(19) United States
(12) Patent Application Publication
(10) Pub. No.: US 2018/0071568 A1
(43) Pub. Date: Mar. 15, 2018

(54) MOVEMENT ACTIVITY TRAINING APPARATUS

(71) Applicants: Pratiksha P. Chesney, Verona, NJ (US); Martha D. Austin, North Plainfield, NJ (US)

(72) Inventors: Pratiksha P. Chesney, Verona, NJ (US); Martha D. Austin, North Plainfield, NJ (US)

(21) Appl. No.: 15/701,696

(22) Filed: Sep. 12, 2017

Related U.S. Application Data
(60) Provisional application No. 62/393,881, filed on Sep. 13, 2016.

(51) Int. Cl. A63B 21/00; A61H 1/00; G09B 19/00

(52) U.S. Cl. CPC A63B 21/4037; A63B 2208/12; G09B 19/003; A61H 1/005

(57) ABSTRACT

Disclosed in certain embodiments is a training mat comprising: a flexible support having a top surface and a bottom surface; a first rail disposed along the top surface of the flexible support; a second rail disposed along the top surface of the flexible support without intersecting the first rail; and a plurality of rungs disposed along the top surface of the flexible support. In certain embodiments, each of the plurality of rails is coupled to flexible support via the first rail and the second rail.

### CROSS-REFERENCE TO RELATED APPLICATION

This application claims the benefit or priority of U.S. Provisional Patent Application No. 62/393,881, filed Sep. 13, 2016, which is hereby incorporated by reference herein in its entirety.

### TECHNICAL FIELD

This disclosure relates to the field of occupational therapy, developmental intervention, and physical therapy, and, in particular, to an apparatus for training a child's movements and positions for achieving developmental milestones.

### BACKGROUND

A significant decline in achievement of developmental milestones in infants, toddlers, and school-aged children has been observed over the past 20 years. For example, one frequently missed major milestone is crawling. Many parents believe their infant's progression from sitting to standing and directly to walking is a positive achievement. However, when a child does not spend significant time maintaining quadruped, rocking in quadruped, and progressing to crawling, one misses out on developing strength within the shoulder girdle, core, back, and pelvic muscles, as well as improving connections between the right and left hemispheres of the brain. Crawling (i.e., advancing right leg and left arm, then left leg and right arm) also has other significant implications affecting development. There are numerous reasons why additional developmental positions/milestones such as tall kneeling, half kneeling, and crossing midline should also be addressed during childhood.

Inadequate and limited early intervention products for children of ages 0-3 results in many children bypassing very important developmental milestones, which can have numerous ramifications as the child ages. Most parents are not aware of the importance of attaining age appropriate developmental milestones in infancy and young childhood. While babies are more frequently surviving premature birth due to medical advancements, this has resulted in more babies with less time spent in-utero and thus requiring days or months in the in neonatal intensive care units (NICUs). These life-sustaining measures inadvertently result in a baby not being able to get the vestibular, proprioceptive, and motor input that a typical developing baby would get in the womb or through a full term birth. Consequently, more infants experience developmental delays, including but not limited to: poor head control, refusal of tummy time, delay in rolling, and transitioning from prone to side sitting. This lack of age appropriate movement results in some children not integrating their primitive reflexes, which hinders function as the child ages. When parents voice their concerns regarding their infants' delays to their pediatrician, early intervention is often warranted.

Largely due to lack of reimbursement from the state or insurance companies, occupational and physical therapies for early intervention (EI) services are frequently denied to the child, or the child is placed on a monthly consultation versus weekly therapy by a trained occupational therapist (OT) or physical therapist (PT). The EI agency will subsequently send out developmental interventionists (DI), who are actually early childhood educators/teachers, rather than a trained OTs or PTs. Parents are often unaware of the significant differences between a skilled OT or PT versus a DI, and at times miss out on the skillsets of OTs and PTs in facilitating said developmental milestones.

### SUMMARY

In one aspect of the present disclosure, a training mat comprises: a flexible support having a top surface and a bottom surface; a first rail disposed along the top surface of the flexible support; a second rail disposed along the top surface of the flexible support without intersecting the first rail; and a plurality of rungs disposed along the top surface of the flexible support. In certain embodiments, each of the plurality of rails is at least partially coupled to flexible support via the first rail or the second rail.

In certain embodiments, at least one of the plurality of rails comprises a fabric.

In certain embodiments, the training mat further comprises a third rail disposed along the top surface of the flexible support between the first rail and the second rail without intersecting either the first rail or the second rail.

In certain embodiments, each of the plurality of rungs is further coupled to the flexible support via the third rail.

In certain embodiments, each of the plurality of rungs is reversibly coupled to the flexible support via the first rail and the second rail.

In certain embodiments the plurality of rungs is evenly distributed along the first rail and the second rail.

In certain embodiments, at least one of the first rail or the second rail comprises a fabric.

In certain embodiments, the flexible support comprises a woven or non-woven fabric.

In certain embodiments the flexible support comprises one or more materials selected from terrycloth, cotton, wool, flannel, flexible polymer, or foam.

In another aspect of the present disclosure, a training mat comprises: a flexible support having a top surface and a bottom surface, wherein the flexible support is planar and rectangular in shape; a first fabric rail disposed along a first edge of the top surface of the flexible support; a second fabric rail disposed along a second edge of the top surface of the flexible support; a third fabric rail disposed along the top surface of the flexible support between the first rail and the second rail, wherein the first rail, the second rail, and the third rail are parallel to each other; a plurality of fabric rungs each reversibly coupled to the flexible support via the first rail, the second rail, and the third rail.

In yet another aspect of the present disclosure, a kit comprises: a flexible support comprising a plurality of fabric rails disposed along a top surface of the flexible support; and a plurality of fabric rungs adapted to reversibly couple to the flexible support via the plurality of rails.

In certain embodiments, the kit further comprises a plurality of cards depicting or describing movements to be performed with the flexible support having the plurality of fabric rungs are coupled thereto.

In certain embodiments, the plurality of fabric rails comprises a first fabric rail, a second fabric rail, and a third fabric rail.

In certain embodiments, the first fabric rail, the second fabric rail, and the third fabric rail are parallel to each other and extend along a length of the flexible support.

In certain embodiments, the first fabric rail is disposed along a first edge of the flexible support, and the second fabric rail is disposed long a second edge of the flexible support opposite the first edge.

In certain embodiments, the third fabric rail is disposed along a central region of the flexible support between the first fabric rail and the second fabric rail.

In certain embodiments, the flexible support comprises a woven or non-woven fabric.

In certain embodiments, the flexible support comprises one or more materials selected from terrycloth, cotton, wool, flannel, flexible polymer, or foam.

In certain embodiments, the plurality of fabric rungs comprises at least nine fabric rungs.

In certain embodiments, each of the plurality of fabric rungs comprises a plurality of attachment sites for reversibly coupling to each of the plurality of rails.

### BRIEF DESCRIPTION OF THE DRAWINGS

The present disclosure is illustrated by way of example, and not by way of limitation, in the figures of the accompanying drawings, in which:

FIG. 1 is a schematic illustration of an embodiment of a training mat;

FIG. 2 is a schematic illustration of an embodiment of a training mat comprising a plurality of rungs affixed thereto;

FIG. 3 is a photograph of an embodiment of a training mat;

FIG. 4 is a photograph of an embodiment of a training mat showing both sides of the training mat; and

FIG. 5 is a photograph of an embodiment of a training mat showing one of the rungs partially detached from the training mat.

### DETAILED DESCRIPTION

Aspects and embodiments of the present disclosure are directed to a training mat and a method of use. Specifically, the training mat is a double-sided training mat which may be accompanied by a set of cards to guide the use of the training mat. In certain embodiments, a first side of the training mat includes lines specifically marked to assist a therapist or parent/caregiver with proper positioning of a child for maintaining developmental postures (which may be described on the cards). To help the child overcome sensory integration difficulties, which may result from pre-mature birth for example, the first side and/or a second side of the training mat may include one or more different materials to enhance tolerance to various textures. The training mat is an easily transportable and washable product that a therapist can use during therapy sessions and as a teaching tool for parents learning to a carry over the activities between therapy sessions.

In certain embodiments, a set of cards (e.g., 12 laminated double-sided cards) may be used to facilitate use of the training mat. For example, a first side of a card may describe or depict one or more motor milestones and depict an activity/position, depict or describe an optimal way the position should be performed, and/or depict or describe how to assist the child into that position. A second side of the card and may include a parent/caregiver-specific description of what the activity is addressing, why it is important to attain this developmental milestone, and long-term benefits as the child ages and/or the consequences of the child not being able to master the activity. The second side may also include explanations of motor planning, how to grade the movements, gross motor, fine motor, visual perception, etc., as well as how the particular skill may translate into real-world function. In certain embodiments, the set of cards is tailored to either a therapist or a parent/caregiver.

As the child ages, different sets of cards may be used that highlight physical therapy/gross motor movements such as specific jumping patterns, walking on a line heel-toe, walking backwards on a line, maintaining balance on the training mat while catching/throwing a ball, stepping sideways, walking on tip toes, walking on heels, side-stepping, bear crawling, cross crawling, etc. Occupational therapy/fine motor activities may include activities such as crossing midline, and while in prone (on belly) blowing a pompom with a straw following a line.

Advantages of the disclosed embodiments include enhancement and flexibility of the quality of services a child can receive in helping the child to achieve key milestones that would otherwise be neglected. The embodiments described herein may be beneficial to PTs and OTs who work primarily with children in school and in early intervention settings. Any PT or OT working in homecare would also benefit from use of the disclosed training mat due to its ease of transport and ease of setup for running a treatment session. Early intervention therapists who visit a child's home (e.g., ages birth to age 3) can easily transport the training mat with them for treatment as well as for teaching the parents/caregivers how to carryover the activity in between therapy sessions. For example, when a child is learning to crawl, the training mat may include markers for measuring distance and as an objective measure of goal markers. Parents/caregivers of children with special needs who are in need of specific techniques to assist their child over breaks in therapy or school will benefit from use of the training mat. Moreover, a video/dvd/internet channel may be utilized to further assist in parent training.

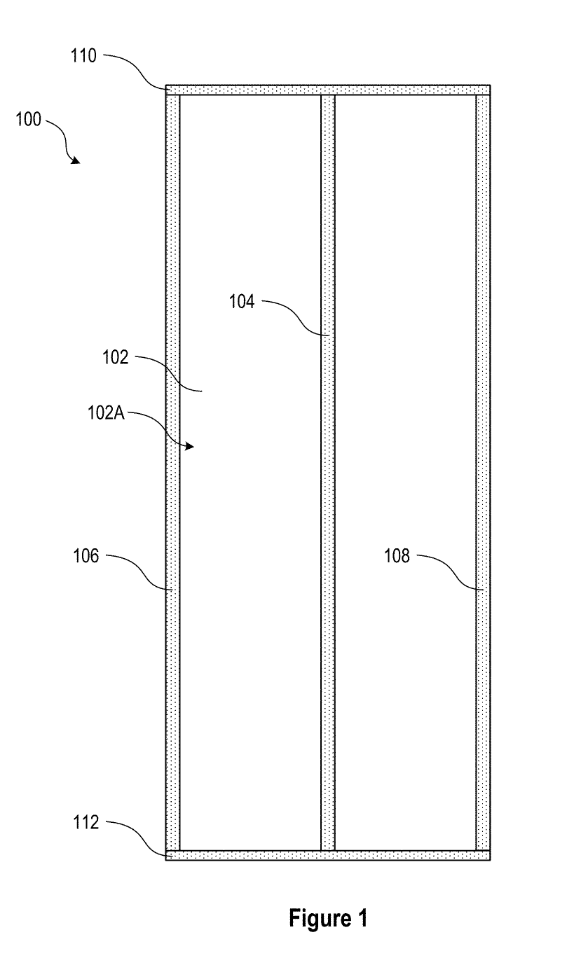

FIG. 1 is a schematic illustration of an embodiment of a training mat 100. The training mat 100 comprises a flexible support 102, which may be made from a durable, soft fabric, such including woven or non-woven fabrics. In certain embodiments, the flexible support 102 is made from a fabric that has the texture and softness similar to a blanket that a child may use (e.g., terrycloth, cotton, wool, flannel, etc.). In certain embodiments, the flexible support 102 may include multiple layers of fabric. For example, the flexible support 102 may include three layers, in which a middle layer of cotton is sewn between the outer layers to add weight to the training mat 100 for sensory integrative purposes, specifically for proprioceptive input. In certain embodiments, the flexible support 102 may comprise a flexible polymer or foam material. In certain embodiments, at least one side of the flexible support 102 may be textured in a way to increase its coefficient of friction, e.g., using a ribbed texture. In certain embodiments, the flexible support 102 may include fabrics with visually stimulating colors for children of ages 0-3. In certain embodiments, the fabric can be a print or a solid color of a flannel material, heavy canvas, microsuede, thermoplastic elastomer, etc. In addition, certain embodiments may show thermographic properties (color change upon contact) to further provide visual and tactile feedback to the user.

In certain embodiments, a top surface 102A of the flexible support 102 includes a left rail 106, a right rail 108, a top rung 110, a bottom rung 112, and a center rail 104 disposed between the left rail 106 and the right rail 108. In certain embodiments, the left rail 106, the right rail 108, the top rung 110, and the bottom rung 112 collectively define a border around an outer edge of the top surface 102A of the training mat 100. The center rail 104 may be used to delineate midline activities during a therapy session. In certain embodiments, one or more of the rails may be present on the top surface 102A as printed markings (e.g., an ink, paint, pigment, etc.) or embedded markings. In certain embodiments, one or more of the rails and rungs may be present on the top surface 102A as ribbons of fabric (or other soft material) that are affixed to the top surface 102A (e.g., sewn, glued, etc.) or formed inline with the material of the top surface 102A. In certain embodiments, one or more of the rails may each be 0.5 to 2 inches wide. In certain embodiments, the positions of one or more of the rails or rungs may vary (e.g., the rails may be displaced from the outer edges of the perimeter of the top surface 102A). In certain embodiments, a bottom surface (opposite the top surface 102A, not shown) of the training mat 100 may not include any rungs or rails, or may have similar patterns of rungs and/or rails formed thereon or attached thereto.

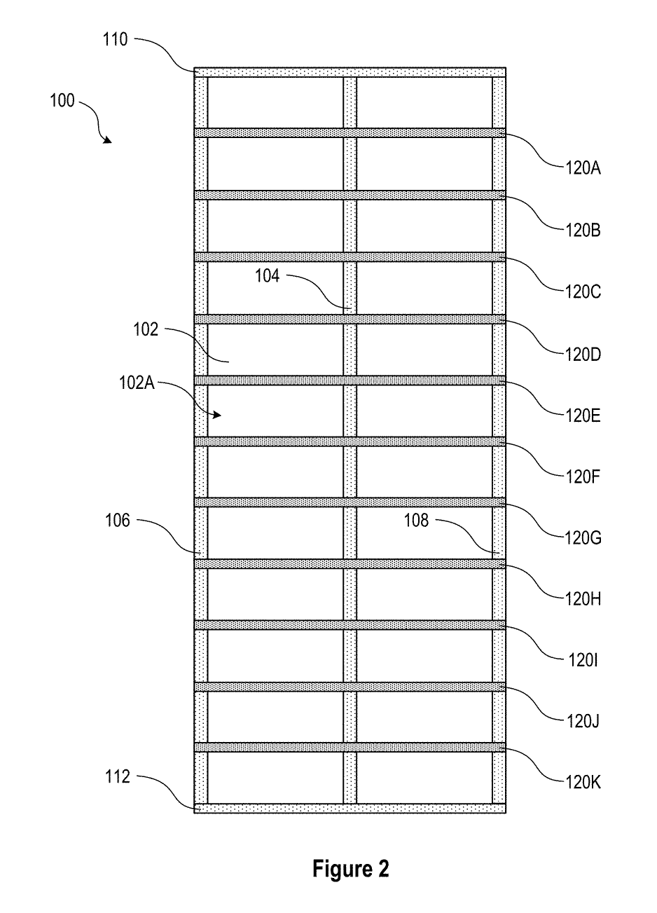

FIG. 2 is a schematic illustration of an embodiment of the training mat 100 further comprising a plurality of rungs 120A-120K affixed thereto. In certain embodiments, the rungs 120A-120K are arranged in an evenly spaced array (e.g., 3 to 12 inches from each other), and may each range from 0.25 to 1 inches in width (e.g., 0.5 inches). Additional rungs, or less than all of the rungs 120A-120K, may be present. For example, at least some of the rungs 120A-120K may be present and spaced apart evenly to define a number of rectangular shapes along a longitudinal direction (i.e., along the longest length of the training mat 100). For example, the training mat 100 may include 9 rungs that define 10 rectangular boxes or squares on each side of the training mat 100, 11 rungs that define 12 rectangular boxes or squares on each side of the training mat 100, etc. A length of the training mat 100 and a spacing between the rungs 120A-120K may be adjusted depending on an intended user. For example, infants/toddlers may use a shorter embodiment of the training mat 100 that has rungs 120A-120K spaced 6 inches apart, while older children may use a longer embodiment of the training mat 100 that has rungs 120A-120K spaced 12 or more inches apart.

In certain embodiments, one or more of the rungs 120A-120K may include one or more fastening members formed thereon or attached thereto for reversibly coupling to the top surface 102A via the rails. For example, fastening members may comprise hook-and-loop fasteners, snap fasteners, etc. In certain embodiments, the left rail 106, the right rail 108, and the center rail 104 may include strips of a “loop” fabric, which may couple to portions of the rungs 120A-120K that have “hook” fabric. In certain embodiments, the “loop” fabric may span a length of each of the rails to allow the rungs 120A-120K to be placed at any desired position along the training mat 100. In certain embodiments, the rails may include the “hook” fabric at certain locations to limit the attachment points of the rungs 120A-120K. In certain embodiments, the rungs 120A-120Z may include male/female fasteners that snap to female/male fasteners located at various positions along the rails.

In certain embodiments, one or more of the rungs may be present as ribbons of fabric that are permanently affixed (e.g., sown) onto the top surface 102A of the flexible support 102 and/or to the rails 106, 104, and 108. In certain embodiments, the rungs are printed onto the top surface 102A, and may further be (or alternatively be) embossed onto the top surface 102A or raised above the top surface 102A. In certain embodiments, one or more of the top rung 110 or the bottom rung 112 may be similar to the rungs 120A-120K, and may be reversibly coupled to, permanently affixed to, or embossed/printed onto the top surface 102A of the flexible support 102.

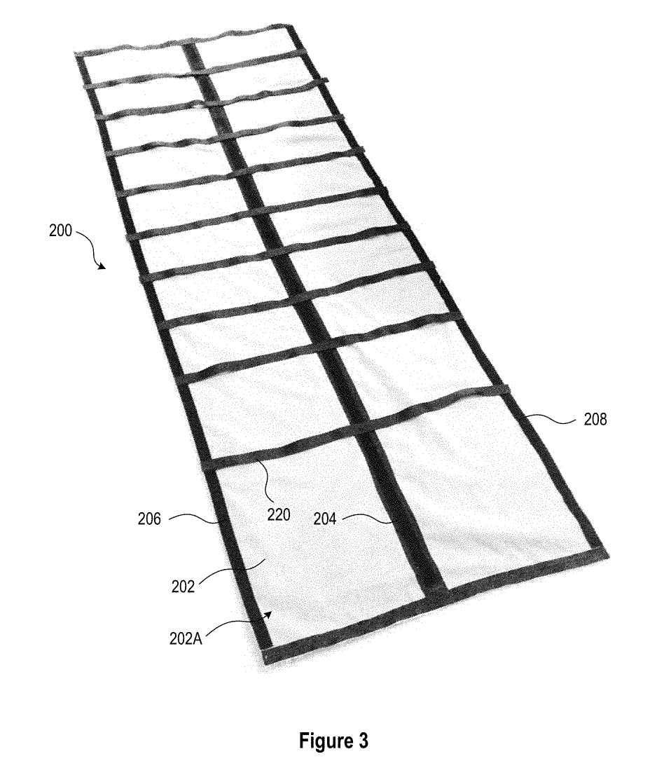

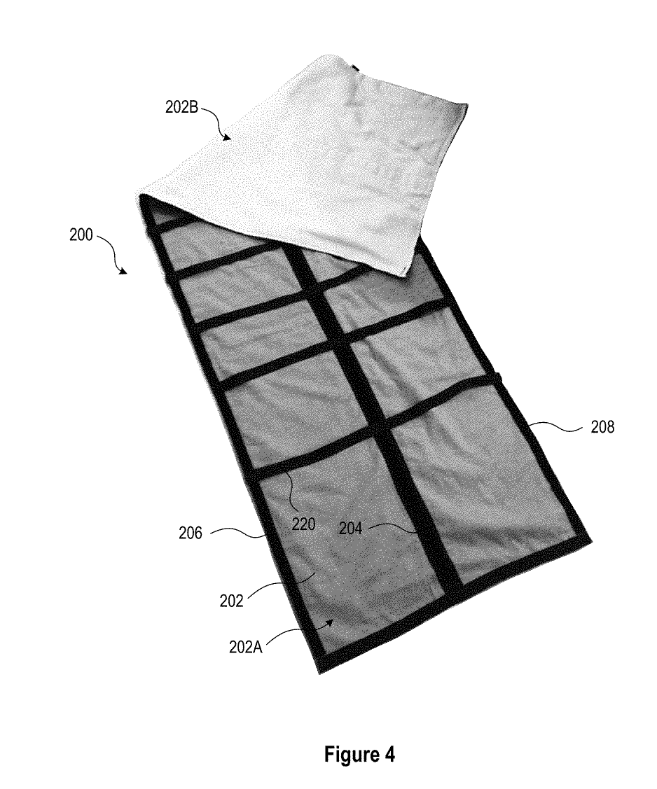

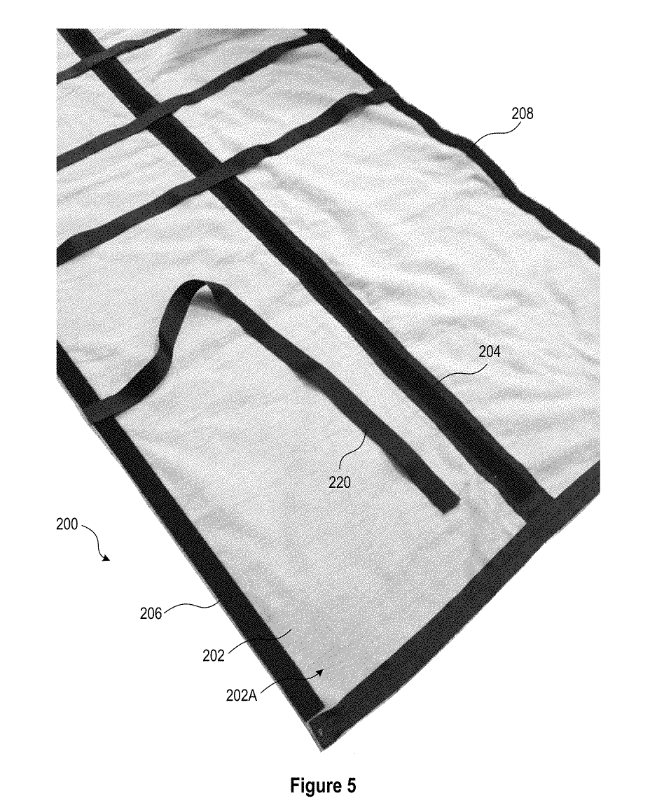

FIGS. 3-5 are photographs of an embodiment of a training mat 200, which may be similar to the training mat 100. As shown in FIG. 3, the training mat 200 includes a flexible support 202 having a top surface 202A, a left rail 206, a right rail 208, a center rail 204, and a rung 220, which may be similar to their identically named counterparts in FIGS. 1 and 2. A rung 220 is reversibly coupled to each of the left rail 206, the right rail 208, and the center rail 204 via hook-and-loop fasteners. A bottom surface 202B of the flexible support 202 is shown in FIG. 4, which may be made from a different material from the top surface 202A. In FIG. 5, the rung 220 is coupled to the left rail 206, but is decoupled from the right rail 208 and the center rail 204.

The various embodiments described herein may be incorporated into a kit for use by a therapist or parent/caregiver. The kit may include any of the embodiments of the training mat, for example, as separate components (e.g., a flexible support, individual rungs, etc.). The kit may further include one or more sets of cards as described above.

In the foregoing description, numerous details are set forth. It will be apparent, however, to one of ordinary skill in the art having the benefit of this disclosure, that the present disclosure may be practiced without these specific details.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise or clear from the context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form. Reference throughout this specification to “an embodiment,” “one embodiment,” and “certain embodiments” means that a particular feature, structure, or characteristic described in connection with the embodiment is included in at least one embodiment. Thus, the appearances of the phrase “an embodiment,” “one embodiment,” and “certain embodiments” in various places throughout this specification are not necessarily all referring to the same embodiment. Moreover, it is noted that the “A-Z” notation used in reference to certain elements of the drawings is not intended to be limiting to a particular number of elements. Thus, “A-Z” is to be construed as having one or more of the element present in a particular embodiment.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A training mat comprising:
a flexible support having a top surface and a bottom surface;
a first rail disposed along the top surface of the flexible support;
a second rail disposed along the top surface of the flexible support without intersecting the first rail; and
a plurality of rungs disposed along the top surface of the flexible support, wherein each of the plurality of rails is at least partially coupled to flexible support via the first rail or the second rail.

2. The training mat of claim 1, wherein at least one of the plurality of rails comprises a fabric.

3. The training mat of claim 1, further comprising:
a third rail disposed along the top surface of the flexible support between the first rail and the second rail without intersecting either the first rail or the second rail.

4. The training mat of claim 3, wherein each of the plurality of rungs is further coupled to the flexible support via the third rail.

5. The training mat of claim 1, wherein each of the plurality of rungs is reversibly coupled to the flexible support via the first rail and the second rail.

6. The training mat of claim 1, wherein the plurality of rungs is evenly distributed along the first rail and the second rail.

7. The training mat of claim 1, wherein at least one of the first rail or the second rail comprises a fabric.

8. The training mat of claim 1, wherein the flexible support comprises a woven or non-woven fabric.

9. The training mat of claim 1, wherein the flexible support comprises one or more materials selected from terrycloth, cotton, wool, flannel, flexible polymer, or foam.

10. A training mat comprising:
a flexible support having a top surface and a bottom surface, wherein the flexible support is planar and rectangular in shape;
a first fabric rail disposed along a first edge of the top surface of the flexible support;
a second fabric rail disposed along a second edge of the top surface of the flexible support;
a third fabric rail disposed along the top surface of the flexible support between the first rail and the second rail, wherein the first rail, the second rail, and the third rail are parallel to each other;
a plurality of fabric rungs each reversibly coupled to the flexible support via the first rail, the second rail, and the third rail.

11. A kit comprising:
a flexible support comprising a plurality of fabric rails disposed along a top surface of the flexible support; and
a plurality of fabric rungs adapted to reversibly couple to the flexible support via the plurality of rails.

12. The kit of claim 11, further comprising:
a plurality of cards depicting or describing movements to be performed with the flexible support having the plurality of fabric rungs are coupled thereto.

13. The kit of claim 11, wherein the plurality of fabric rails comprises a first fabric rail, a second fabric rail, and a third fabric rail.

14. The kit of claim 13, wherein the first fabric rail, the second fabric rail, and the third fabric rail are parallel to each other and extend along a length of the flexible support.

15. The kit of claim 14, wherein the first fabric rail is disposed along a first edge of the flexible support, and wherein the second fabric rail is disposed long a second edge of the flexible support opposite the first edge.

16. The kit of claim 15, wherein the third fabric rail is disposed along a central region of the flexible support between the first fabric rail and the second fabric rail.

17. The kit of claim 11, wherein the flexible support comprises a woven or non-woven fabric.

18. The kit of claim 11, wherein the flexible support comprises one or more materials selected from terrycloth, cotton, wool, flannel, flexible polymer, or foam.

19. The kit of claim 11, wherein the plurality of fabric rungs comprises at least nine fabric rungs.

20. The kit of claim 11, wherein each of the plurality of fabric rungs comprises a plurality of attachment sites for reversibly coupling to each of the plurality of rails.
